(19) United States
(12) Patent Application Publication
(10) Pub. No.: US 2018/0093699 A1
(43) Pub. Date: Apr. 5, 2018

(54) Ball Screw Drive and Motor Vehicle Steering System Equipped with Same

(71) Applicant: Robert Bosch Automotive Steering GmbH, Schwäbisch Gmünd (DE)

(72) Inventors: Oliver Hetzel, Waldstetten (DE); Michael Jueschke, Spraitbach (DE); Werner Bernhard, Mögglingen (DE)

(21) Appl. No.: 15/562,489

(22) PCT Filed: Feb. 9, 2016
(86) PCT No.: PCT/EP2016/052662

§ 371 Date: Sep. 28, 2017

(30) Foreign Application Priority Data
Mar. 31, 2015 (DE) 10 2015 104 925.2

(51) Int. Cl. B62D 5/04; F16C 33/04; B62D 3/08

(52) U.S. Cl. CPC B62D 5/0448; F16C 2326/24; B62D 3/08; F16C 33/04

(57) ABSTRACT

A ball screw drive includes a lead screw for converting an auxiliary torque produced by an electric motor into an auxiliary translational force which acts on a steering rack in the steering system of a motor vehicle. One end of the lead screw and one end of the steering rack are each connected to a track rod via an axial link, and the ball screw drive has a ball nut mounted in a housing with a fixed bearing. In order to withstand lateral loads or lateral forces coming from the track rod or rods and acting in the radial direction, there is provided between an end of the lead screw connected to the track rod and the ball screw drive a plain bearing element which supports the lead screw radially against the housing.

The invention relates to a ball screw drive and to a steering system, equipped with said ball screw drive, of a motor vehicle. In particular, the invention relates to a ball screw drive which comprises a threaded spindle for converting an assistance torque generated by an electric motor into a translational assistance force which acts on a toothed rack in the steering system of the motor vehicle.

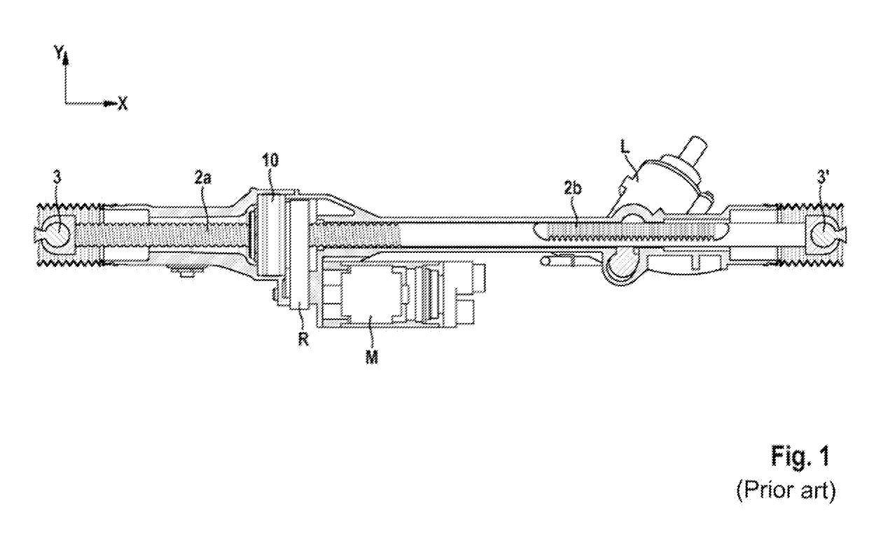

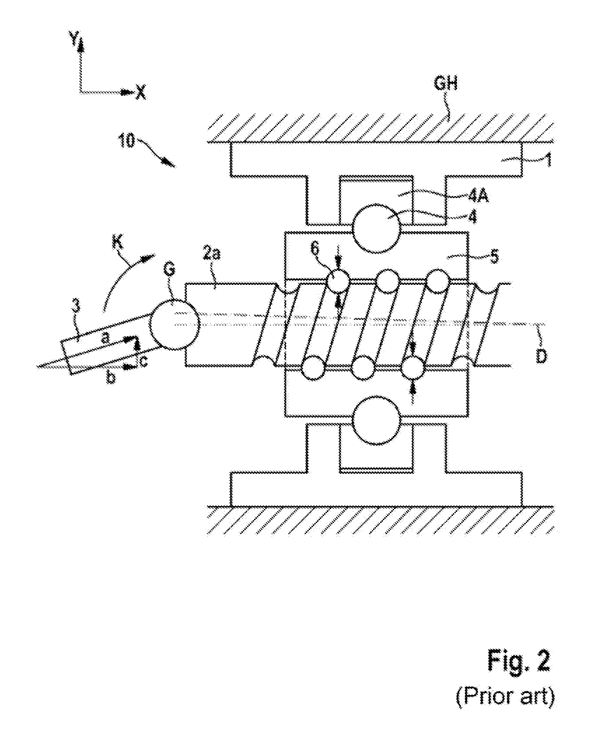

In the field of motor vehicle steering systems, it is well known to use ball screw drives for the purposes of converting a rotational assistance force (torque) generated by an assistance motor (electric motor) into a translational assistance force which acts on a threaded spindle or toothed rack of the steering system. FIG. 1 schematically illustrates such a construction. As can be seen in said figure, the threaded spindle 2a and the toothed rack 2b of the steering system are deflected by means of the ball screw drive 10, wherein the end of the threaded spindle 2a is connected by means of an axial joint G to a track rod 3; at the end of the toothed rack 2b, the latter is correspondingly connected articulatedly to a track rod 3′. The toothed rack 2b is in engagement with the pinion of a steering gear L. The ball screw drive 10 is driven by an electric motor M via a belt R or the like. FIG. 2 illustrates the construction of the ball screw drive in detail: the ball screw drive 10 has a ball nut 5 which is mounted in a housing 1 by means of a fixed bearing 4, which ball nut, together with the threaded spindle 2a and the circulating balls 6, forms the major part of the ball screw drive and can rotate about the axis of rotation D. The fixed bearing 4 accommodates substantially only axial forces, and is thus not loaded in the radial direction.

A ball screw drive of said type is known for example from DE 10 2012 110 081 A1. Said type of ball screw drive is commonly used in electric power steering systems, so-called EPS (Electric Power Steering) systems.

It is furthermore known, for example from DE 10 20010 029 266 A1, for a ball screw drive of the type mentioned in the introduction to be further developed such that at least one spring element “24” is arranged on each face side of the fixed bearing, in particular on the outer ring of the fixed bearing (see FIG. 2 of said document). In this way, at the fixed bearing, an elasticity of the bearing arrangement is realized, whereby shock loads acting in an axial direction can be damped in an effective manner.

FIG. 2 illustrates a conventional ball screw drive 10 in the case of which, in everyday use, the problem arises that in particular the transverse force component c of the track rod force a (generated by the given angles of the respective track rods 3 in the vehicle) poses a major challenge with regard to the assembly of a ball screw drive (BSD) in an EPS system. If the steering system is not capable of accommodating the, in some circumstances, very high transverse forces, damage to the ball screw drive (hereinafter also referred to as recirculating-ball screw) and to the BSD bearing can arise, which leads inter alia to a significant impairment of the acoustic characteristics. As can be seen in FIG. 2 on the basis of the graphic breakdown of the track rod force a into the components b and c, the transverse force component c of the track rod force a leads to a radial load, that is to say to a transverse load of the ball screw drive 10 acting in a radial direction Y. Said transverse load has the effect not only that the threaded spindle 2a and track rod 2b can bend elastically but also that a corresponding tilting moment K is generated in the ball screw drive 10. The tilting moment K in turn gives rise to a particularly high load on the first balls 6 in the screw drive and on the final balls. This is indicated in FIG. 2 by the arrows. High tilting moments are supported there in the front and rear regions of the ball circuit and generate a high Hertzian stress in the “ball-on-raceway” and “ball-on-ball” points of contact, in particular in the outer thread turns of the ball nut 5. This in turn leads to a high level of damage and a severe reduction in service life, and to deformation in the ball raceway and/or on the balls, which then results in significant acoustic impairment in the ball screw drive.

The invention is thus based on a conventional ball screw drive which comprises a threaded spindle for converting an assistance torque generated by an electric motor into a translational assistance force which acts on a toothed rack in a steering system of a motor vehicle, wherein one end of the threaded spindle and one end of the toothed rack are connected in each case by means of an axial joint to a track rod, wherein the ball screw drive has a ball nut which is mounted in a housing by means of a fixed bearing (which can accommodate only axial forces).

It is an object of the present invention to considerably improve a ball screw drive of the type mentioned in the introduction such that the abovementioned disadvantages are advantageously overcome. In particular, the ball screw drive should be designed for installation in steering systems such that even high transverse loads do not lead to high loads in the ball circuit of the ball screw drive.

The object is achieved by means of a ball screw drive having the features of claim 1. Also proposed is a steering system which is equipped with a ball screw drive of said type.

The ball screw drive according to the invention is distinguished by the fact that a plain bearing element is arranged between that end of the threaded spindle which is connected to the track rod and the ball screw drive, which plain bearing element supports the threaded spindle radially with respect to the housing.

The plain bearing element is preferably formed as a plain bearing bushing which surrounds the threaded spindle, wherein the plain bearing bushing is mounted cardanically in the housing and accommodates the transverse force component, resulting from the track rods, of the toothed rack.

By means of the invention disclosed here, between the ball screw drive (referred to for short as BSD) and the coupling of the track rod, there is provided a plain bearing which supports the threaded spindle radially and which can accommodate occurring transverse forces, whereby transverse loads (BSD and BSD bearing see only axial forces) are prevented in an effective manner from being able to act directly on the ball circuit or on the bearing thereof. The invention is preferably realized by means of a plain bearing bushing which is cardanically mounted in the housing so as to be pivotable.

A plain bearing point positioned very close to the force introduction point results in less bending of the toothed rack and reduced loads on the threaded spindles, on the BSD and of the BSD bearing. In this way, it is possible to use smaller threaded spindles or toothed rack diameters, and also to provide fewer thread turns in the ball circuit, without exceeding the admissible strengths. In this way, the construction of the steering system can be realized in a very inexpensive manner. Furthermore, the entire ball chain is subjected to lower load, whereby the robustness with regard to the operating characteristics is considerably increased.

The invention also relates to a steering system for a motor vehicle, which steering system is equipped with a ball screw drive of said type, and also relates to a plain bearing element per se, which is suitable for the construction of a ball screw drive of said type. In this regard, reference is also made to the coordinate claims.

The abovementioned advantages and further advantages also emerge from subclaims, which specify advantageous refinements of the invention.

Accordingly, the plain bearing bushing preferably has a ring-shaped outer circumference which is convexly curved, in particular is curved in the manner of a spherical cap. In this context, it is advantageous if at least a first subregion of the outer circumference of the plain bearing bushing bears against an inner wall, which is concavely curved, of the housing. In this way, a semi-cardanic mounting of the plain bearing bushing is realized in a very efficient manner.

It is preferably the case that at least a second subregion of the outer circumference of the plain bearing bushing bears against the inner wall, which is concavely curved, of a ring which is insertable into the housing. The insertable ring may be fixed in a desired position by means of a fixing element. In this way, the installation of the plain bearing bushing into the housing is simplified; furthermore, the cardanic mounting of the bushing can be set to a possibly desired degree of play.

Alternatively, in a second exemplary embodiment, the plain bearing bushing may, at its two ends, be secured against displacement in the axial direction by in each case one round-wire ring. For this purpose, the plain bearing bushing preferably has, on its outer circumference, two grooves in which the round-wire rings are received. It may furthermore be provided that the inner wall of the plain bearing bushing has a bevel, or is beveled, at both ends of the bushing.

The plain bearing element or the plain bearing bushing is preferably manufactured from metal, in particular steel or aluminum, or from plastic, in particular a polyamide.

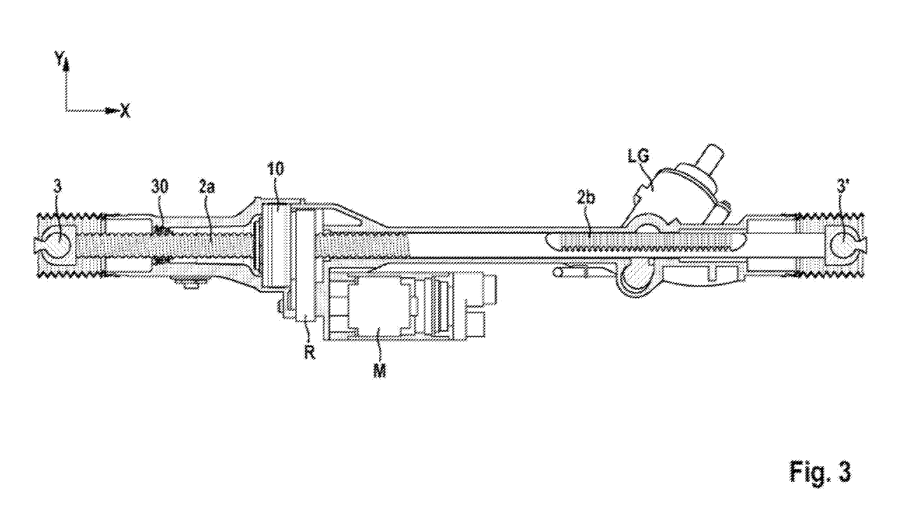

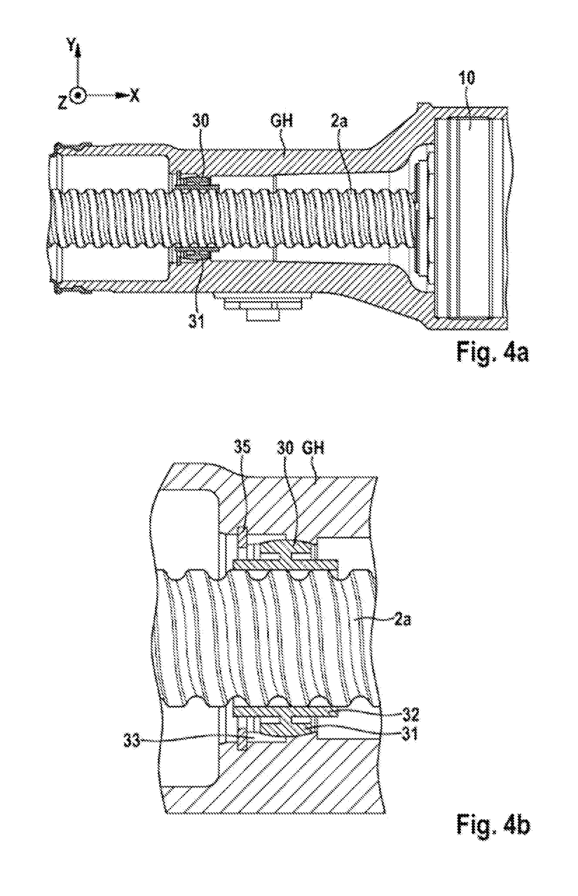

The invention will be described in detail below on the basis of exemplary embodiments which relate to a steering system for a motor vehicle and with reference to the appended drawings FIGS. 3, 4a/b and 5a/b, which show the following schematic illustrations:

FIG. 3 shows, in cross section, the construction of a steering system which is equipped with a ball screw drive according to the invention;

FIGS. 4a/b show, in detail, the installation of a plain bearing element according to a first exemplary embodiment in the form of a cardanically mounted plain bearing bushing; and

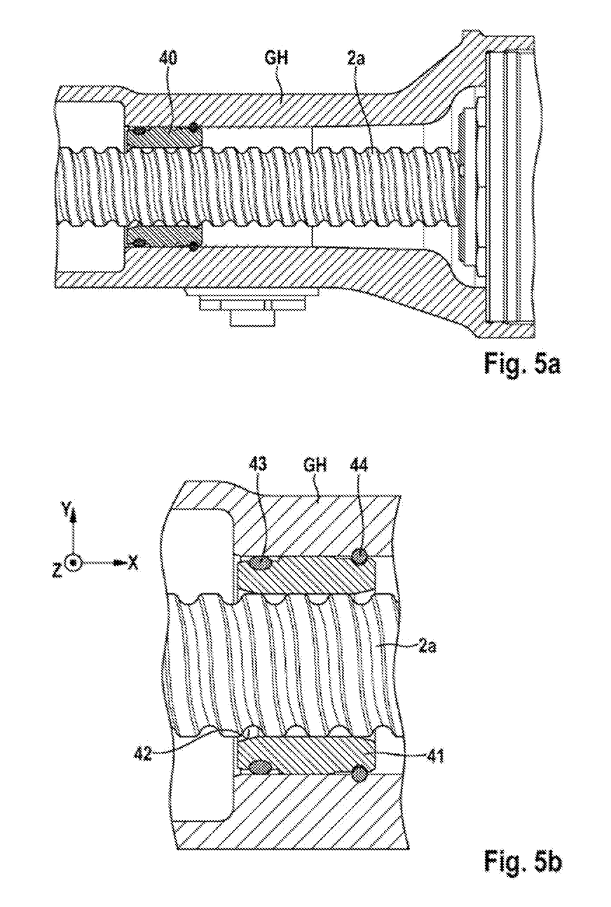

FIGS. 5a/b show, in detail, the installation of a plain bearing element according to a second exemplary embodiment in the form of a plain bearing bushing secured by means of round-wire rings.

The ball screw drives illustrated in FIGS. 3 and 4 also have components which are already present and denoted by reference designations in FIGS. 1 and 2. Therefore, the reference designations for the following components are maintained: steering system housing GH with steering gear LG and ball screw drive 10 in the housing (part) 1; ball nut 5; inner region or ball circuit with balls 6; threaded spindle 2b with its axis of rotation D; fixed bearing 4; toothed rack 2b; joint G for the coupling of the respective track rod 3 or 3′; belt R, and motor M.

Below, for the description of the first exemplary embodiment, reference will be made to FIGS. 3-5a/b:

FIG. 3 shows, in cross section, the construction of a steering system which is equipped with a ball screw drive 10 according to the invention. The ball screw drive 10 comprises the threaded spindle 2a, which is formed so as to be structurally integral with the toothed rack 2b of the steering system. The collective unit will hereinafter also be referred to in simplified form as toothed rack. To the two free ends of the collective unit there is articulatedly connected a respective track rod 3 and 3′. To prevent high transverse loads, that is to say high transverse forces in the radial direction Y, overloading the ball circuit of the ball screw drive 10, a plain bearing element 30 is arranged between the ball screw drive 10 and the free end of the threaded spindle 2a, that is to say the end connected to the track rod 3, which plain bearing element supports the threaded spindle 2a radially with respect to the housing GH.

As shown in greater detail in FIGS. 4a/b, the plain bearing element is formed as a plain bearing bushing 30 which surrounds the threaded spindle 2a. The bushing 30 is composed substantially of a ring-shaped body with a smooth inner wall 32 and with a convexly curved outer circumference 31. In the example shown here, said part of the bushing has the form of a spherical cap, approximately half (right-hand half in FIG. 4b) of which is received in a concavely shaped section of the housing GH. The other half of the spherical cap 31 (left-hand half in FIG. 4b) is held by a ring 33 which is insertable into the housing or by the concavely shaped inner wall of said ring, such that the spherical cap and thus the entire plain bearing bushing 30 can be positioned at the desired location so as to be pivotable about the z axis. A fixing element in the form of a ring 35 serves for fixing the arrangement.

The exemplary embodiment illustrated in FIGS. 4a/b thus shows a cardanically mounted bushing 30 which is pivotable about the z axis, which radially supports the threaded spindle 2a, and which can accommodate transverse forces (in the y direction). In this way, the ball circuit, in particular the first and final ball raceways, are protected against overloading. The contacting or the play between the plain bearing bushing 30 and the housing GH can be optimally set by means of the fixing element 35. The bushing itself or the ring-shaped body 30 may have incisions (as shown in FIG. 4b) for the purposes of saving material and weight. If desired, the incisions or narrowings of the material may also be of relatively thin dimensions in order to achieve a certain elasticity.

A second embodiment of the invention will be described below on the basis of FIGS. 5a/b: a likewise ring-shaped body is used as plain bearing element 40, which body has the form of a plain bearing bushing and comprises the threaded spindle 2a. The inner wall of the plain bearing element or of the plain bearing bushing 40 is likewise of flat and smooth form in the inner region. The two ends of the bushing 40 may be beveled, that is to say may have bevels 42. The bevels facilitate the assembly process and are advantageous with regard to the bending line and the rotation of the thread.

On the outer circumference of the bushing 40 there are provided grooves which extend in each case in a circumferential direction and which receive in each case one round-wire ring 43 and 44 respectively. The round-wire ring 43 and 44 make contact with the inner wall of the housing GH, such that the plain bearing bushing is (cardanically) mounted so as to be pivotable to a small extent. Furthermore, in the center of the bushing 40 (see FIG. 5b), the outer circumference 41 has a slight convex curvature, and is formed for example in the manner of a spherical cap. The spherical cap is axially fixed by means of one of the round-wire rings, in this case by means of the right-hand ring 44. After a deflection of the arrangement (under the action of an occurring transverse load), a central position is automatically set by means of the O-ring. In this way, automatic centering is realized in the solution illustrated in FIGS. 5a/b. This function is not implemented in the example from FIGS. 4a/b.

In most applications, the installation location of the plain bearing bushing 30 or 40 should preferably be situated close to the free end of the threaded spindle 2a, that is to say as close as possible to the connection joint for the track rod 3 (see also FIG. 3). In this way, transverse force components acting on the track rod can be better supported/accommodated. In the present example, the bushing 30 or 40 itself is composed of a polyamide of type PA-6, though may also be manufactured from other suitable plastics, and alternatively from metal, such as for example steel or aluminum.

The invention is particularly suitable for being installed in the steering system of a motor vehicle, in particular in a steering system with electrical power steering assistance. By means of the invention, lighter-weight design and construction variants can be realized, because smaller threaded spindles or toothed rack diameters are possible. A shorter construction of the ball nut is also possible, because fewer thread turns are required. The performance and operating characteristics are considerably improved by means of a non-braced ball chain.

In summary, the invention relates to a ball screw drive 10 which is used in a steering system. The ball screw drive 10 comprises a threaded spindle 2a for converting an assistance torque generated by an electric motor M into a translational assistance force which acts on a toothed rack 2b in the steering system of a motor vehicle, wherein one end of the threaded spindle 2a and one end of the toothed rack 2b are connected in each case by means of an axial joint G to a track rod 3, 3′, wherein the ball screw drive 10 has a ball nut 5 which is mounted in a housing GH by means of a fixed bearing 4. In order to be able to withstand high transverse loads or transverse forces originating from the track rod(s) 3, 3′ and acting in the radial direction y, a plain bearing element 30 is arranged between that end of the threaded spindle 2a which is connected to the track rod 3 and the ball screw drive 10, which plain bearing element supports the threaded spindle 2a radially with respect to the housing GH. The plain bearing element is preferably formed as a plain bearing bushing 30 which is cardanically mounted in the housing GH so as to be pivotable at least about a transverse axis z which is oriented perpendicular to a direction y in which a transverse force component c of a track rod force a arises. The plain bearing bushing 30 preferably has a ring-shaped outer circumference 31 which is convexly curved, in particular is curved in the manner of a spherical cap. At least a first subregion of the convex outer circumference 31 bears against a concave subregion of the inner wall of the housing GH. The BSD bearing, using the bearing arrangement proposed here, accommodates only axial forces, and may thus be designed as a pure axial ball bearing.

The use of round steel rings or O-rings (as shown in FIGS. 5a/b) gives rise to automatic centering of the slide bushing: if the toothed rack is subjected to radial load, the bending line profile of the toothed rack results in relation to the bearing arrangement. The cardanic plain bearing arrangement in this case supports the radial force. Since the bushing, contrary to the theoretical calculation approach, does not have the “ideal structural length of 0 mm”, it follows, along its length, the profile of the bending line of the toothed rack. If the transverse force is now eliminated, the toothed rack assumes the neutral position again within its bearing arrangement, and carries the cardanic plain bearing along, but not completely. Owing to bearing play between toothed rack and plain bearing, a small residual angle remains, which has an adverse effect with regard to contact pattern and in particular friction. If an O-ring is now installed between housing and plain bearing, said O-ring likewise deforms elastically under the action of transverse force during pivoting of the plain bearing. If the transverse force is now eliminated, the O-ring seeks to assume its original shape again, and returns the plain bearing into the central position (the O-ring generates a restoring moment).

### LIST OF REFERENCE DESIGNATIONS

10 Ball screw drive

1 Housing of the ball screw drive

2a Threaded spindle and 2b Toothed rack

3, 3′ Track rod

4 Fixed bearing with 4A Outer ring

5 Ball nut

6 Balls or ball circuit

GH Housing of the steering system

L Steering gear

D Axis of rotation

G Axial joint for the articulated connection of the track rod to the threaded spindle or toothed rack

a Track rod force (can be broken down into the components b and c)

b Axial force component

c Transverse force component

K Tilting moment

x, y, z Spatial axes or direction coordinates

R Belt

M Electric motor

30 Plain bearing (first example) in the form of a cardanically mounted plain bearing bushing without centering

31 Ring-shaped outer circumference, convexly curved, for example in the manner of a spherical cap

32 Inner wall of the plain bearing bushing

33 Wedge-shaped/concavely shaped ring

35 Fixing element/fixing ring

40 Plain bearing (second example) in the form of a cardanically mounted plain bearing bushing with centering

41 Outer circumference, slightly convexly curved and equipped with grooves

42 Beveled ends

43, 44 Round-wire rings in the grooves

1. A ball screw drive comprising:
a threaded spindle configured to convert an assistance torque generated by an electric motor into a translational assistance force which acts on a toothed rack in a steering system of a motor vehicle, one end of the threaded spindle and one end of the toothed rack connected in each case by an axial joint to a track rod;
a ball nut mounted in a housing by a bearing; and
a plain bearing element arranged between the one end of the threaded spindle connected to the track rod and the toothed rack, the plain bearing element configured to support the threaded spindle radially with respect to the housing.

2. The ball screw drive as claimed in claim 1, wherein:
the plain bearing element includes a plain bearing bushing surrounding the threaded spindle, and
the plain bearing bushing is mounted cardanically in the housing so as to be pivotable at least about a transverse axis which is oriented perpendicular to a direction in which a transverse force component of a track rod force arises.

3. The ball screw drive as claimed in claim 2, wherein the plain bearing bushing has a convexly curved ring-shaped outer circumference.

4. The ball screw drive as claimed in claim 3, wherein:
at least a first subregion of the outer circumference of the plain bearing bushing bears against a concavely curved inner wall, of the housing.

5. The ball screw drive as claimed in claim 2, wherein:
at least a second subregion of the outer circumference of the plain bearing bushing bears against a concavely curved inner wall of a ring, and
the ring is insertable into the housing.

6. The ball screw drive as claimed in claim 5, wherein the ring is fixed in a desired position by a fixing element.

7. The ball screw drive as claimed in claim 2, wherein:
a first round-wire ring secures a first end of the plain bearing bushing against displacement in an axial direction, and
a second round-wire ring secures a second end of the plain bearing bushing against displacement in the axial direction.

8. The ball screw drive as claimed in claim 7, wherein an outer circumference of the plain bearing bushing has two grooves in which the first and second round-wire rings are received.

9. The ball screw drive as claimed in claim 7, wherein:
the first end of the plain bearing bushing has a first bevel, and
the second end of the plain bearing bushing has a second bevel.

10. A steering system with electrical power steering assistance for a motor vehicle comprising:
a track rod;
a toothed rack;
an electric motor; and
a ball screw drive including
a threaded spindle configured to convert an assistance torque generated by the electric motor into a translational assistance force which acts on the toothed rack, one end of the threaded spindle and one end of the toothed rack connected in each case by an axial joint to the track rod,
a ball nut mounted in a housing by a bearing, and
a plain bearing element arranged between the one end of the threaded spindle connected to the track rod and the toothed rack, the plain bearing element configured to support the threaded spindle radially with respect to the housing.

11. A plain bearing element for a ball screw drive including a threaded spindle, the plain bearing element comprising:
a housing; and
a plain bearing bushing surrounding the threaded spindle and mounted in the housing, the plain bearing bushing configured to support the threaded spindle radially with respect to the housing.
